(19) United States
(12) Patent Application Publication
(10) Pub. No.: US 2003/0085584 A1
(43) Pub. Date: May 8, 2003

(54) Interchangeable pick-up truck bedliner/cap

(76) Inventor: Mark A. Golden, Washington, MI (US)

Correspondence Address: General Motors Corporation, Legal Staff, Mail Code 482-C23-B21, P.O. Box 300, Detroit, MI, 48265-3000, US

(21) Appl. No.: 10/001,996

(22) Filed: Nov. 3, 2001

(51) Int. Cl. B60P 3/42; B60R 13/01

(52) U.S. Cl. 296/39.2; 296/10; 296/100.02

(57) ABSTRACT

A unitary removable bedliner for use in conjunction with the cargo box of a pick up truck is formed by a bottom wall, a pair of opposing sidewalls extending upward from the bottom wall, and a front wall also extending upward from the bottom between the opposing walls. Each wall has a rail extending perpendicular to and outwardly from its upper edge. The bedliner is preferably formed of a thermoplastic or thermoset material and is molded to form fit the cargo box, including the wheel well covers, of the pick up truck. The rails of the bedliner align with and rest upon the corresponding rails of the cargo box. The rails may be formed with stake pockets corresponding to stake pockets within the cargo box rails for continued use if desired. The tailgate of the pick up truck may not be covered by the bedliner, allowing access to the cargo space.

### TECHNICAL FIELD

The present invention relates to an interchangeable pick up truck cargo bedliner and cap.

### BACKGROUND OF THE INVENTION

In view of improvements in styling and comfort, the pick up truck continues to remain a popular vehicle for use by the general public. A typical pick up truck includes a cargo box having a floor and being bordered by a front wall, contiguous sidewalls and a tailgate commonly formed of painted steel. The exposed surfaces of the truck cargo box are prone to scratching, denting and corrosion from general use. Bed liners, preferably formed from thermoplastic or thermoset material, are an economical and attractive way to protect the metal surfaces of the truck cargo box.

The open nature of a cargo box of a pick up truck, with or without a bedliner, is such that the cargo held is potentially vulnerable to conditions such as weather, theft or the like. A variety of tonneau covers for covering the open bed are available. Alternatively, a truck bed cap may be permanently attached to the front and sidewalls of the bed. The cap has a front wall, two contiguous sidewalls and a tailgate mirroring the identical elements forming the truck bed. The cap is usually constructed of metal and provides additional cargo area above the truck bed.

The present invention provides a pick up truck bedliner that is interchangeable between a liner and a truck bed cap for temporarily transporting objects under cover within a pick up truck bed.

### SUMMARY OF THE INVENTION

The present invention provides a unitary removable bedliner for use in conjunction with the cargo box of a pick up truck either as a bedliner or as a protective cover for the cargo box. The bedliner is formed by a bottom wall, a pair of opposing sidewalls extending upward from the bottom wall, and a front wall also extending upward from the bottom wall between the opposing sidewalls. The front wall and opposing sidewalls terminate at a flange extending perpendicular to and outwardly from its upper edge. The bedliner is preferably formed of a plastic material, namely a formable thermoplastic or thermoset material and is molded to form fit the cargo box, including wheel well covers where the cargo box design contains them, of the pick up truck. The bedliner includes flanges for aligning with and resting upon the corresponding rail of the cargo box for securing the bedliner within the cargo box. The flanges may be formed with stake pockets corresponding to stake pockets within the cargo box rails to allow for their use, if desired. The bedliner may also be provided with a tailgate liner that mirrors the rotation of the tailgate of the pick up truck. Alternatively, the tailgate may not be covered by the bedliner, allowing direct access to the cargo space.

The unitary bedliner is purposely lightweight so that it may readily be removed and rotated 180° about its center to rest on the rails of the cargo box to form a protective cap for the bed. The truck bed cap may be attached along the corresponding cap flanges and cargo box rails by any suitable means, such as a bolt and nut, snap down, sliding lock or other like fastener.

Accordingly, it can be seen that the present invention offers and advantage over both conventional bedliners and conventional bed caps, by performing the function of each at the user's discretion.

These and other objects of the present invention will become apparent upon reading the following detailed description in combination with the accompanying drawings, which depict systems and components that can be used alone or in combination with each other in accordance with the present invention.

### BRIEF DESCRIPTION OF THE DRAWINGS

FIG. 1 illustrates a perspective view of the cargo box of a pick up truck and a preferred embodiment of a unitary removable bedliner of the present invention;

FIG. 2 illustrates a perspective view of the cargo box of a pick up truck and a preferred embodiment of the truck bed cap of the present invention, and

FIG. 3 illustrates a cross-sectional view of the flange of the truck bed cap attached to the corresponding rail of the cargo box.

### DESCRIPTION OF THE PREFERRED EMBODIMENT

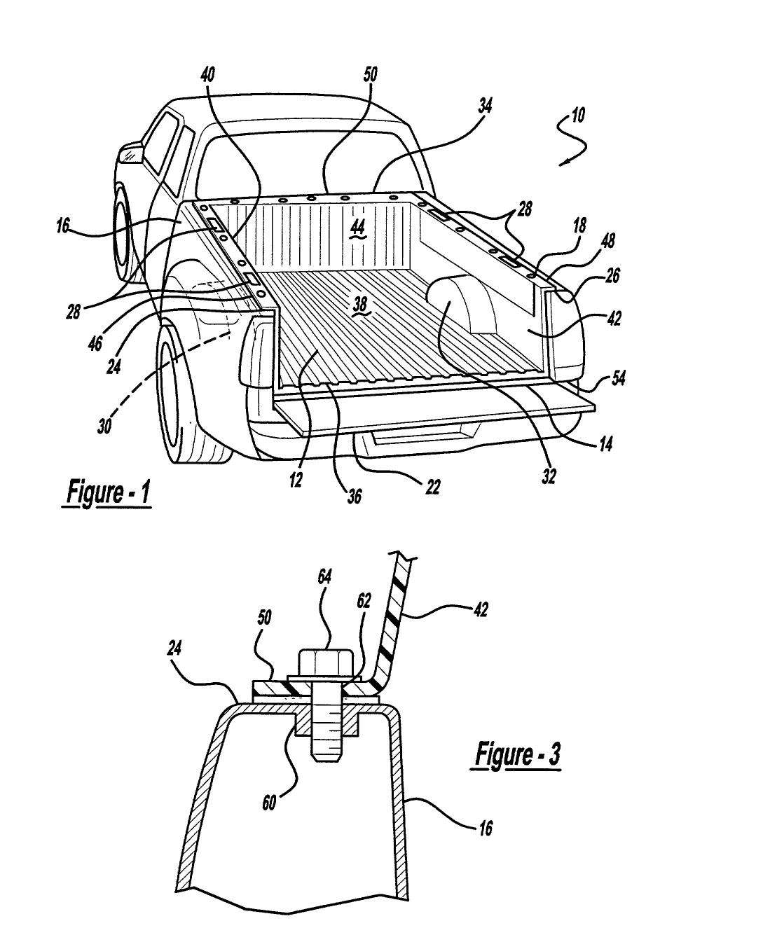

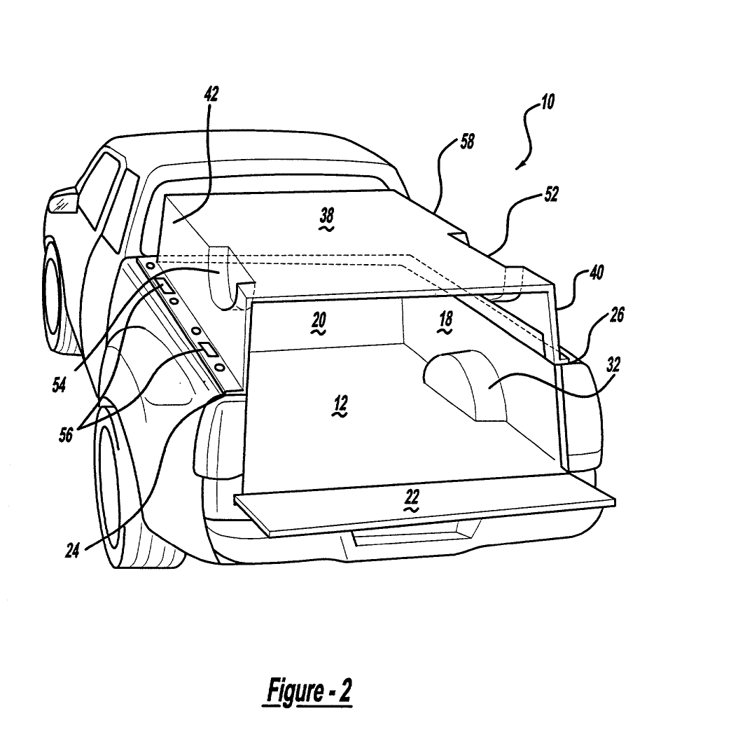

FIGS. 1 and 2 illustrate a pick up truck 10 having a cargo box 12 defined by a bottom wall 14, a pair of opposing sidewalls 16,18 a front wall 20, and a tailgate 22. Like the pick up truck 10, the cargo box 12 is generally made of sheet material, such as metal (e.g. steel.) The opposing sidewalls 16,18 extend upwardly from the bottom wall 14 and form side rails 24,26. These rails 24,26 may also include openings or stake pockets 28, preferably having a rectangular perimeter for supporting wooden or metal stakes or railings within the rails of the cargo box 12 for providing an extended cargo area. Wheel well covers 30,32 are formed within the opposing sidewalls 16,18. The front wall 20 also extends upwardly from the bottom wall 14 and forms a forward sill 34. The forward sill 34 may continuously adjoin the side rails 24,26. The conjoined rails 24,26 and sill 34 help to afford sealing about the top edges of the cargo box 12.

As best shown in FIG. 1, a unitary removable bedliner 36 of the present invention is there shown. The bedliner 36 is preferably formed of a rigid material, such as a thermoplastic or thermoset material that may be formed to fit the corresponding features of the cargo box 12 of the pick up truck 10. The bedliner 36, therefor, has a bottom wall 38; two opposing sidewalls 40, 42 (FIG. 2;) and a front wall 44 extending upwardly between the sidewalls 40,42. Each sidewall 40,42 extends upwardly from the bottom wall 38 and forms a flange 46,48. The front wall 44 also culminates in a flange 50. Flanges 46,48,50 extend outwardly from the walls 40,42,44 respectively, to rest atop inwardly extending rails 24,26, and sill 34 of the cargo box 12. For some applications, the sidewalls 40,42 of the bedliner 36 may also be formed to include wheel well covers 52,54 (that may optionally be omitted where not needed, such as some sportside or stepside applications) and stake pockets 56. In a preferred embodiment, the bedliner 36 does not include a fourth wall, thereby allowing full usage of the tailgate and access to the cargo box 12. Alternatively, the bedliner 36 may be furnished with a tailgate liner corresponding to the swing of the tailgate 22. The bedliner 36 protects the underlying sheet metal of the cargo box 12 from the elements, eliminating rusting, scratching of the paint and any other external forces that may damage the cargo box 12.

With reference to FIGS. 2 and 3, the bedliner 36 has been removed from the cargo box 12 and rotated 180° (i.e., upside down) to form a truck bed cap 58. The truck bed cap 58 is preferably secured to the cargo box 12 of the pick up truck 10 by a releasable attachment arrangement. By way of example and as shown in FIG. 3, rail 24 of opposing sidewall 16 of the cargo box 12 may be formed with a reinforced eyelet 60. Flange 50 of opposing side 42 of the truck bed cap 58 may be formed with a hole 62 corresponding to eyelet 60. By way of example, a nut and bolt arrangement 64 is then used to temporarily secure the truck bed cap 58 to the cargo box 12. The truck bed cap 58 provides temporary security and relief from the elements of objects within the cargo box 12 during transport. A removable hatch may be provided between opposing walls 40,42 and bottom wall 38, now the ceiling of the truck bed cap 58, for additional security features. The tailgate 22 may still swing freely when in the cap position. Stake pockets 56 within the truck bed cap 58 correspond to stake pockets 28 of the cargo box 12 and may be also used when the cap is in place.

The person of skill in the art will recognize that features and aspects of an interchangeable pick up truck cargo bedliner and cap disclosed herein may be used in any combination described as desired, needed or as may be possible.

The present invention may be employed with fleetside, sportside or stepside beds, the bedliner having a structural silhouette forming to the corresponding cargo box of the individual beds. The overall structure of the bedliner is sufficiently rigid to be generally self-supporting (e.g. it will not sag or roll on under its own weight from torsional forces as would a conventional molded bedliner.) Any number of structural reinforcements may be molded or added to the bedliner of the present invention. Such reinforcements may be in the form of vertical or horizontal ribs within the bottom wall and outside walls (as shown in FIG. 1). Alternatively, ribs may be provided diagonally, cross-vehicle, or like, to any wall of the bedliner. The liner may also be formed from spaced apart opposing side panels, optionally provided with a foam layer there between. The thickness of the liner may be increased to provide additional structural reinforcement. Though the panels defining the liner may be thinner, they preferably are configured so that the liner ranges in section profile thickness averages from about 0.01″ to about 1.5″, and more preferably about 0.2″ to about 1″ (e.g. on the order of about 0.5″.) The present invention may be provided as original equipment or available as an after market purchase. Additionally, the invention may be packaged with a hoist system to aid the owner in removing and rotating the bedliner between the two positions.

As described above, the bedliner may also be provided with a tailgate preferably having structurally reinforcements as described above. The tailgate may also be provided with a locking mechanism for use when the bedliner has been rotated to the truck bed cap position. Alternatively, the bedliner may include a transparent front wall or window panel within the front wall providing additional rear vision for the driver into the enclosed cargo box when the bedliner is in the truck bed cap position. If a bedliner tailgate is provided, a window panel or transparent tailgate (such as a polycarbonate panel) may also be formed, providing complete rear vision through the entire cargo box when the bedliner is in the truck bed cap position.

The fasteners used to attach the truck bed cap to the cargo box rails may be of any form. In particular, screw-down clamps, over-center clamps, or locking pins on tracks may be provided on the bedliner flanges and the corresponding cargo box rails.

The bedliner may be constructed as multiple panels joined together or as a single unitary structure that has been injection molded, blow molded, thermoformed or the like, such as is preferred for thermoplastic or thermoset materials. Additionally, the bedliner may be compression molded, reaction molded, or the like. The multiple panel or unitary bedliner may be purchased and assembled as original equipment or purchased separately after market and assembled by an after market distributor.

It should be understood that the invention is not limited to the exact embodiment or construction that has been illustrated and described but that various changes may be made without departing from the spirit and the scope of the invention.

1. A unitary removable bedliner for use in conjunction with the cargo box of a pick-up truck, the bedliner comprising:
a bottom wall;
a pair of opposing side walls extending upwardly from said bottom wall, each of said side walls having a flange extending perpendicular to and along the length of said side walls for mating with said cargo box of said truck; and
a front wall extending upwardly from said bottom wall and adjoining said opposing side walls, said front wall having a flange extending perpendicular to and along the length of said front wall for mating with said cargo box of said truck;
wherein said unitary bedliner is self-supporting;
wherein said unitary bedliner is releasably attached to said cargo box along said flanges;
wherein said bedliner is removably rotatable from a first position within said cargo box to a second position above said cargo box to function as a truck bed cap releasably attached to said cargo box along said flanges and forming an open compartment between said cargo box and said bottom wall.

2. The bedliner of claim 1, wherein portions of said opposing side walls form wheel well covers between said bottom wall and said flanges.

3. The bedliner of claim 1, wherein said opposing side wall flanges include structure defining a stake pocket.

4. The bedliner of claim 1, wherein said front wall flange includes structure defining a stake pocket.

5. The bedliner of claim 1, wherein said releasable attachment of said bedliner to said cargo box comprises a fastener.

6. The bedliner of claim 1, wherein said bedliner is formed for defining a rigid structure.

7. The bedliner of claim 1, wherein said bedliner is formed of a thermoplastic or thermoset material.

8. The bedliner of claim 6, wherein said rigid structure comprises a section profile thickness on order of about 0.5″.

9. A cargo box and bedliner assembly comprising:
a cargo box having a bottom wall, a pair of opposing sidewalls, a front wall and a tailgate, and having a rail extending along the upper edges of the front and sidewalls; and
a bedliner comprising a rigid, unitary structure formed of a molded thermoplastic or thermoset material that is removable and rotatable from a first position above said cargo box and forming a cap for said cargo box to a second position within said cargo box to function as a cargo bedliner;
said bedliner further comprising:
a bottom wall;
a pair of opposing side walls extending upwardly from said bottom wall, each of said side walls having a flange extending perpendicular to and along the length of said side walls for mating with the railing of said cargo box of said truck; and
a front wall extending upwardly from said bottom wall and adjoining said opposing side walls, said front wall having a flange extending perpendicular to and along the length of said front wall for mating with said cargo box of said truck;
said bottom wall of said bedliner further comprising ribs molded vertically along the length of said wall and forming structural integrity to said wall;
said opposing side walls of said bedliner further comprising ribs molded vertically along the length of said walls and forming structural integrity to said walls: and
wherein said mating of said bedliner flanges to said cargo box rails comprises a nut and bolt for temporarily securing said bedliner to said cargo box in said first position.

10. The bedliner of claim 9, wherein said bedliner is releasably attached to said cargo box in said first and second positions.

11. The bedliner of claim 10, wherein portions of said opposing side walls form wheel well covers between said bottom wall and said flanges.

12. The bedliner of claim 10, wherein said opposing side wall flanges include structure defining a stake pocket.

13. The bedliner of claim 10, wherein said front wall flange includes structure defining a stake pocket.
